(19) United States
(12) Patent Application Publication
(10) Pub. No.: US 2010/0259213 A1
(43) Pub. Date: Oct. 14, 2010

(54) PORTABLE DEVICE CHARGING STATION WITH ADVERTISING DISPLAY

(76) Inventor: Ashwin C. Maharaj, Vancouver (CA)

Correspondence Address: STITES & HARBISON, PLLC, 400 W MARKET ST, SUITE 1800, LOUISVILLE, KY, 40202-3352, US

(21) Appl. No.: 12/756,816

(22) Filed: Apr. 8, 2010

(30) Foreign Application Priority Data
Apr. 8, 2009 (CA) 2662201

(51) Int. Cl. H02J 7/00; G06F 3/041

(52) U.S. Cl. 320/107; 345/173

(57) ABSTRACT

A battery charging station for at least one personal electronic device, which is associated with a display is provided. The charging station would allow people to obtain a quick charge on their personal electronic device, and they would be shown various visual content on the display while the charge was taking place. The device lends itself particularly well to use in airports, malls, hotel lobbies and other public locations. Chargers for various types and voltages of personal electronic devices could be provided in the charging station to allow different types of personal electronic devices to be charged by the charging station.

This invention is in the field of personal electronic devices and their use and battery charging by users in transit. More specifically it deals with a public battery charging terminal for at least one such device, which incorporates a display for displaying images or video.

### BACKGROUND

Many types of portable electronic devices are widely used in the marketplace today. These portable electronic devices (PEDs) include cell phones, MP3 players, personal digital assistants such as Blackberry™ devices or the like, and even video or digital still cameras are used for messaging and information storage and exchange and retrieval.

These devices are all typically battery driven, and as the battery is drained it is necessary to recharge the battery on its functionality. In fact, portable electronic devices (for example a PDA) may indicate “low battery” at a time when its user is in a location where the device would be most needed, such as an airport waiting to board a flight which departure time has been changed etc. In this situation, a user would be denied the use of their device, such as a cell phone or the like, unless there is a readily available charger or charging station to recharge the battery.

Particularly in the case of business travelers, people who have forgotten or lost the charger for their PDA or who are quickly charging their device by plugging into electrical outlets in an airport terminal or the like are a regular sight. One of the problems or limitations however with the use of these devices is simply that, the fact that carrying the charger during travel can either at the least result in the need to transport an extra cable or device which makes packing more difficult, and on many occasions either on departure on a business trip or upon return the user will find that they have either at their home before departure forgotten to bring along the charger, or have even left the charger that they brought with them behind in their hotel room or the like. If it was possible to provide some type of a compact and low-cost charging device or alternatively to provide a publicly available charging station by which an individual could charge their device without the need to even carry along the charger of any kind it is believed that this would be a popular item or approach.

The present invention deals with a combination of present day problems or scenarios sought to be solved by various business people. In addition to the market for a publicly available device charging station, as a part of the business model for provision of these devices it is believed that this could be combined as a new method of advertising. Generally speaking, advertising screens or billboards are located at various corners and points in public places such as highways, bus stops, elevators, shopping malls, train stations and airports etc. It is believed that the addition of a battery charging station for PEDs to the base of a billboard or advertising display would allow not only for the repurpose of an otherwise unused space that could also result in the assembly of a captive audience to view the advertising display of these devices, insofar as a consumer who was awaiting the charging of their PED would be standing there in front of the display or sitting there in front of the display and would thus be an audience for whatever advertising was being shown.

Increased viewing traffic created by the use of a charging station or method as outlined herein could also assist in the rectification of current economic problems experienced by billboard users and owners who are experiencing lower viewing traffic. An increase in the competitiveness of billboard or display advertising as well as a rise in the revenue generated from the sale of products or services advertised through these displays could aid in the more rapid market adoption of the proposed invention.

### SUMMARY OF THE INVENTION

In one aspect, a charging station for charging a personal electronic device is provided. The charging station comprises: an enclosure; at least one charging interface for charging a personal electronic device; at least one transformer operatively connected to the at least one charging interface to supply power to the at least one charging interface for charging the personal electronic device; a display unit operative to display visual content in response to a user charging a personal electronics device using the charging station; and a power cord for connecting the charging station to a local power source.

In another aspect, a charging station for charging a personal electronic device is provided. The charging station comprises: an enclosure; at least one charging interface for charging a personal electronic device; at least one transformer operatively connected to the at least one charging interface to supply power to the at least one charging interface for charging the personal electronic device; a display unit interface operative to connect to a display unit and display visual content on the display unit in response to a user charging a personal electronics device using the charging station; and a power cord for connecting the charging station to a local power source.

In another aspect, a method is provided. The method comprises: providing a charging station for charging a personal electronic device and a display unit associated with the charging station; and in response to a personal electronic device being connected to the charging station to be charged, displaying visual content on the display unit associated with the charging station.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a perspective view of the front of one embodiment of a freestanding charger station in accordance with the present invention;

FIG. 2 is a rear view of the device and embodiment of FIG. 1;

FIG. 3 is a schematic illustration of one implementation of the charging station shown in FIG. 1;

FIG. 4 is a perspective view of the front of a further embodiment of a charging station in accordance with the present invention;

FIG. 5 is a rear view of the charging station shown in FIG. 4;

FIG. 6 is a flowchart illustrating a method of displaying visual content in response to a user connecting his or her personal electronic device to a charging station;

FIG. 7 is a flowchart illustrating a method of operating a charging station using a control system;

FIG. 8 is a flow chart illustrating a method of displaying visual content in response to a user connecting his or her personal electronic device to a charging station wherein the visual content is selected based upon detection of the type of personal electronic device or devices connected to the charging station; and

FIG. 9 is a flowchart illustrating a method of operating a charging station using a control system wherein the visual content is selected based upon detection of the type of personal electronic device or devices connected to the charging station.

### DETAILED DESCRIPTION OF THE ILLUSTRATED EMBODIMENTS

In one embodiment, a method and apparatus for a public charging station for personal electronic devices with an integrated or associated display is provided. The device of the present invention comprises a charging station, which would be publicly available and would allow for the charging of the batteries in at least one personal electronic device.

### Concurrent Charging of Multiple Devices:

Any type of portable device which requires battery charging is a device within the concept of personal electronic devices contemplated for charging or use in association with the charging station of the present invention.

While we speak specifically of the charging station of the present invention being capable of charging at least one personal electronic device it will be understood that additional power charging outputs could be provided on the device which would allow for the concurrent charging of more than one personal electronic device at the same time and that a charging station which charges one or more personal electronic devices concurrently is contemplated to all be within the scope of the present invention.

### General Device Overview:

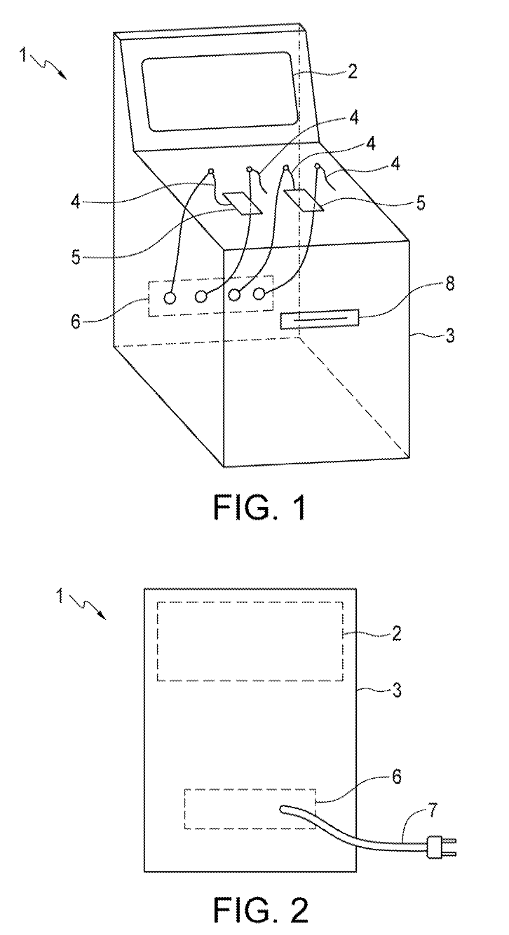

Referring to FIGS. 1 and 2, there are shown a front perspective view and rear view of one embodiment of the charging station 1 of the present invention. The charging station 1 can include an enclosure 3, a display unit 2, a plurality of charging interfaces 4 and one or more power transformers 6.

The enclosure 3 can be used to house the components of the charging station 1. The enclosure 3 can be sized so that it is high enough for a user to use the device when they are standing in front of it. Alternatively, the enclosure 3 can be sized so that it can fit on a table top, etc.

The display unit 2 can be provided on top of the enclosure 3 positioned so that a user using the charging station 1 to charge his or her personal electronic device 5 can easily see the display unit 2. In one aspect, the display unit 2 can be mounted towards the rear of the enclosure 3.

On a top surface of the enclosure 3 a plurality of charging interfaces 4 can be provided. The charging interfaces 4 are connectable to one or more types of personal electronic devices allowing passerbys to connect their personal electronic devices 5 to the charging station 1. In one aspect, the charging interfaces 4 can be positioned on a top surface of the enclosure 3 in front of the display unit 2.

The charging interfaces 4 can be any suitable connection allowing a user to connect his or her personal electronic device 5 to the charging station 1. The charging interfaces 4 could be power cords so that a user can connect his or her personal electronic device 5 to the power cord in order to charge it. In another aspect, the charging interfaces 4 could be docking stations with the docking stations being specifically sized and shaped to be connectable to a certain type or types of personal electronic devices 5. The charging interfaces 4 on the charging station 1 could also be a mixture of power cords and docking stations.

The enclosure 3 is shown in dotted relief in FIG. 1, illustrating the interior of the enclosure 3. The power transformer 6 housed within the enclosure 3 is shown in FIG. 1. The power transformer 6 can be used to interface the charging interfaces 4 with the local power source at the location of the charging station 1 allowing a user to charge his or her personal electronic device 5 by connecting it to one of the charging interfaces 4.

As outlined herein, the number of charging interfaces 4 could be one or more, dependent upon the number of personal electronic devices 5 that it was desired to be able to concurrently charged at the charging station 1 at the same time and/or the number of different types of personal electronic devices 5 that are desired to be used with the charging station 1. A single transformer 6 is shown in the interior relief portion of these Figures, however, it will be understood that a single type of transformer leading to one or more charging interfaces 4 could allow for the charging of multiple devices at the same time, or alternatively, it could also be the case that multiple transformers each of which terminated in one or more charging interfaces 4 could be used as an interface to the same local power source so that for example different transformer outputs, plug-ins or voltages could be provided so that multiple types of personal electronic devices 5 could be charged at the charging station 1.

The display unit 2 which is shown at the top rear of the device 1 can be a display which could display visual content such as images, video, animations, etc., such as advertising material, during the charging of personal electronic devices 5 and which could rotate the material as desired. The display unit 2 itself could be a contained display and could be as simple as a pre-manufactured digital photo frame or similar device, or something more customized could be used which could allow for a network connection, a more elaborate type of streaming media display or the like.

In one aspect, the display unit 2 may be a touchscreen or other interactive element which would allow for the users of the charging station 1 to actually interact or browse visual content contained on or accessible to the charging station 1.

In one embodiment, the charging station 1 could include a printer 8 or something similar so that if in an interactive context the user wanted a copy of a coupon or an advertisement or something, it could be printed out by the charging station 1 on the printer 8.

Referring to FIG. 2, the rear of the charging station 1 is shown. The dotted relief shown in FIG. 1 shows the display unit 2 to the front of the device as well as the transformer 6 which would be involved in converting a local power source to the necessary power outputs for the charging of the personal electronic devices 5. A power cord 7 can be provided to allow the charging station 1 to be connected to a local power supply, such as a wall outlet. The power cord 7 can be operably connected to the transformers 6 to supply power to the transformer 6, which in turn will power the charging station 1 and charge personal electronic devices 5 using the charging interfaces 4.

### Types of Charging or Power Outputs:

In addition to the fact that the charging station 1 of the present invention is explicitly contemplated to be capable of charging more than one personal electronic device 5 concurrently, it will also be understood that by providing variable power outputs or various types of charging interfaces on the charging station 1, more than one personal electronic device 5 of more than one kind could be concurrently charged on the charging station 1 at the same time and again it is explicitly contemplated that the provision of variable power outputs or various power connections for charging of different types of personal electronic devices 5 on the charging station 1 of the present invention is within the scope hereof, and that the provision of whatever additional types of power transformer equipment or the like are necessary in the charging station 1 to provide these variable power outputs will be understood to one skilled in the art and will again also be contemplated and understood to be within the scope of the invention as outlined herein.

In one embodiment, the charging station 1 would have a transformer 6 or charger equipment which would allow for quick or rapid charging of batteries, rather than slower deep charging equipment. It will be understood that the concept of the present invention would accommodate both, in the context of the anticipated use of the charging station of the present invention, the provision of “quick charge” equipment versus deep charging equipment which would take a longer time to charge a battery of a device.

### Revenue Recovery:

While the primary means of revenue generation of the method and apparatus of the present invention is anticipated to be fees generated from advertisers interested in displaying their advertising material on the display of one or more of the charging stations of the present invention, it will also be understood that the apparatus could be quickly modified based upon whether or not it was desired to provide the actual charging service for batteries of the device for free, or whether it was desired to charge people to use the charging station of the present invention.

It may in fact be the case that to provide use of the device for free would enhance the advertising revenue model, since with free use likely more people would try to use the charging station 1 of the present invention and would generate a larger audience or add views for which advertisers may be prepared to pay more money. It will be understood that to add a coin or credit card operation to the charging station would be simply done and is contemplated within the scope of the present invention.

### Nature of the Display:

The display unit 2 could be any type of suitable display capable of displaying the desired visual content. The display unit 2 could be a fairly simple electronic display such as an LCD panel or the like connected either to a computer or even to some streamlined kernel-based controller which could display either in a static or rotating fashion visual content obtained from a flash card or other memory device. In one aspect, the display unit 2 could be three-dimensional display that displays visual content with a three dimensional effect.

The visual content which could be still images, animations, videos, etc. which could either be rotated on a predetermined frequency basis or could stay the same for a longer period of time, or given that in one embodiment the display unit 2 is explicitly contemplated to be connected to a computer system of some sort, with the installation of the necessary or appropriate software on the computer system which drives the display unit 2, the visual content which is displayed could also be streaming video and corresponding audio or the like.

In an embodiment of the charging station 1 of the present invention which was being constructed with commercially available components that do not require significant custom design, a digital photo frame might actually be used as the display unit 2 of the charging station 1 of the present invention.

The display unit 2 could be connected to a computer network, via the Internet or otherwise, either for the purpose of providing a completely active or dynamic rotation of visual content for display on the display unit 2 or for the provision of a simple download mechanism by which revised or new visual content could be downloaded to the charging station 1 from time to time. It will be understood that this type of a networked device, or a standalone device for which the memory would need to be updated by way of a physical visit to the site of the charging station 1 by an operator or attendant are both contemplated within the scope of the present invention.

In a further elaborate embodiment of the charging station of the present invention, the display unit 2 could alter the types of visual content which was being displayed based upon the types of personal electronic devices 5 which were detected to be attached for charging. This could be accomplished either by requiring a person who wished to use the charging station 1 to specify the type of device 5 in order to activate the proper charger, or it may even be possible to provide a more elaborate electronic embodiment for the automatic sensing of the type of device 5, and all such embodiments of the charging station 1 of the present invention, wherein the visual content displayed on the charging station 1 by the display unit 2 was modified based upon the number or type of devices 5 connected to the charging station 1 at that particular time are contemplated within the scope of the present invention.

In this manner, if the visual content was advertising, advertising being displayed on the display unit 2 of the charging station 1 could be selected based on the type of personal electronic device 5 being charged by the charging station 1. For example, when a mobile phone is being charged with the charging station 1, visual content showing advertising relating to mobile phone users might be provided, however, when the personal electronic device 5 being charged is a MP3 player, the visual content might be advertising directed at MP3 player users.

The visual content could also be information that may be desirable to a user of the charging station, such as breaking news, disasters or other emergency situations. This visual content could be streamed to the charging station 1 as the events are happening and displayed on the display unit 2 so that the charging station 1 can act as means of providing visible alerts even when a personal electronic device is not being charged by the charging station.

It will also be understood that there could be a non-electronic display unit 2 used although beyond the retrofit context this may not be the norm in terms of the rendering of units in accordance with the present invention. It is conceivable however that the electric charging aspect of the charging station 1 of the present invention could be combined with an older traditional moving paper billboard or the like which could also comprise the display unit 2 in accordance with the display requirements of the present invention and would be contemplated within the scope hereof as well.

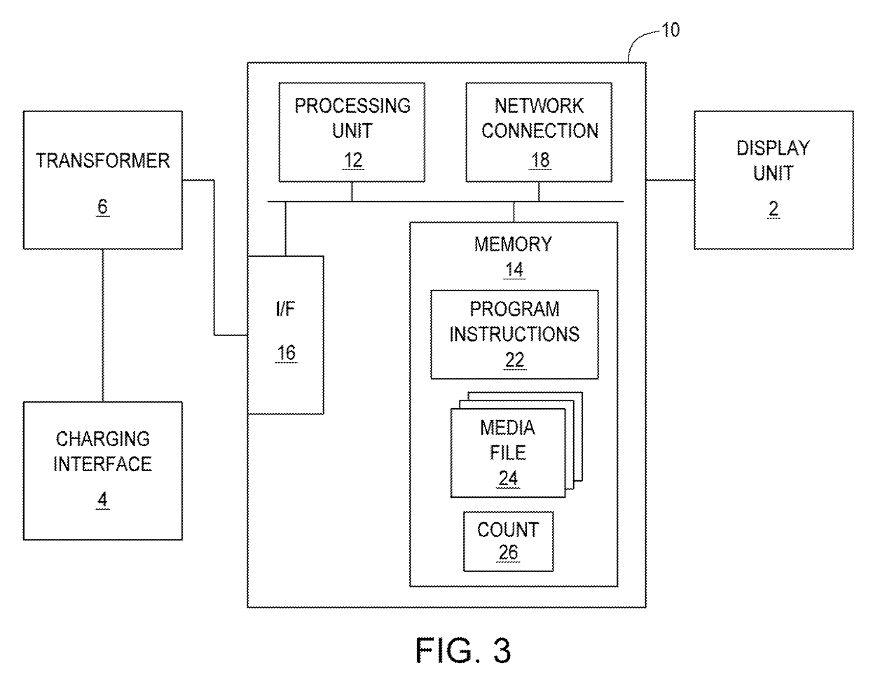

FIG. 3 illustrates an implementation of the charging station 1 in one aspect that uses a control system 10 for controlling the operation of the charging station 1. The control system 10 can include a processing unit 12, a memory 14, an interface 16, and optionally, a network connection 18. A person skilled in the art will appreciate that various other components may be used in the control system 10, such as busses, power supplies, cooling components, etc. that are not specifically shown in FIG. 3.

The processing unit 12 can be a microprocessor or other similar device for controlling the operation of the charging station 1 and displaying visual content on the display unit 2 in response to a user connecting his or her personal electronic device 5 to the charging station to be charged.

The memory 14 can be any suitable computer readable memory such as a RAM, ROM, hard disk, flash drive, combination of these types of memories, etc. that is suitable for storing data to be accessed by the processing unit 12. The memory 14 can contain program instructions 22 that are executable by the processing unit 12 and that can be used to control the operation of the processing unit 12 and thereby the operation of the charging station 1. The memory 14 can also contain one or more media files 24. Each media file 24 can contain data that can be used by the processing unit 12 to display visual content on the display unit 2 by the processing unit 12. In one aspect, the media file 24 could contain image data that can be used to display a static visual image, such as a picture or other static image. In another aspect, the media file 24 could be a video file that can be used to display video or an animation on the display unit 2. The media file 24 may or may not contain audio data, along with the visual data, that can be played during the display of the visual data on the display unit 2.

In one aspect, the media file 24 could contain data related to an advertisement advertising a product and/or service.

The interface 16 can be used to allow the processing unit 12 to determine when a personal electronic device 5 is being charged by the charging station 1. If the charging station 1 is provided with more than one charging interface 4, the interface device 16 could allow the processing unit 12 to determine which of the different charging interfaces 4 are being used to charge a personal electronic device 5.

Alternatively, the processing unit 12 can receive user input from a user where a user manually selects what type of personal electronic device 5 he or she is charging with the charging station 1.

The processing unit 12 can be operably connected to the memory 14, the display unit 2, and the interface device 16. The processing unit 12 can be operative to, in response to determining that a user has connected his or her personal electronic device 5 to the charging station 1 to be charged, access one of the media files 24 stored on the memory 14. The processing unit 12 can then use the accessed media file 24 to display visual content on the display unit 2 based on the data stored in the media file 24. In this manner, when a user connects his or her personal electronic device 5 to the charging station 1, one of the media files 24 can be used to display visual content (and possibly audio content) on the display device 2, such as a static image, video or animation.

A single media file 24 can be used to display a single image or play a single video while a user is charging his or her personal electronic device 5 using the charging station 1. In the case of the media file 24 being a video, the video can be set on a loop to be replayed as long as the personal electronic device 5 is being charged. Alternatively, the processing unit 12 can select a number of different media files 24. In this manner, if the media files 24 contain data that can be used to display a static image on the display unit 2, the processing unit 12 can display a number of different static images like a slideshow. If the media files 24 contain data that can be used to show a motion video or animation on the display unit 2, the processing unit 12 can select another media file 24 stored on the memory 14 after a previous video or animation has finished and a personal electronic device 5 is still being charged using the charging station 1. In this manner, a series of videos/animations can be shown on the display unit 2 while a personal electronic device 5 is being charged on the charging station 1.

In one embodiment, the processing unit 12 may display different visual content on the display unit 2 simultaneously. The processing unit 12 may access a number of media files 24 and use the data in these different media files 24 to display different visual content simultaneously on the display unit 2. This different visual content could be in different segregated sections on a screen of the display device 2 or it could be overlaid on the display device 2 to create a composite visual image. In this manner, advertising material, for example, could be displayed with local news, weather, the current time, etc.

The processing unit 12 can also be used to track the number of times the charging station 1 has been used to charge a personal electronic device 5. The processing unit 12 can store a count 26 in the memory 14 each time the processing unit 12 determines that a user has connected a personal electronic device 5 to the charging station 1.

If more than one type of charging interface 4 is used, the processing unit 12 can be operative to determine which type of charging interface 4 a user has connected his or her personal electronic device 5 to and select one of the media files 24 based on the type of charging interface 4 used. In this manner, content displayed on the display device 2 can be selected based on the type of electronic device 5 that is being charged on the charging station 1.

If more than one type of charging interface 4 is used, the processing unit 12 can be used to store different counts 26 in the memory 14, one count for each different type of charging interface 4 that is used in the charging station 1. In this manner, the charging station 1 can be used to track the number of times different types of personal electronic devices 5 are charged using the charging station 1 based on the type of charging interface 4 that is used.

Alternatively, the processing unit 12 can receive user input from a user indicating on the charging station 1, such as by a button or the display unit 2 being a touchscreen display, what type of personal electronic device 5 he or she is charging and the processing unit 12 could use this input to maintain the counts 26 in the memory 14.

In one aspect, the charging station 1 may be provided with a network connection 18. This network connection 18 could be used to allow the charging station 1 to be connected to a network, such as the internet, local network, etc. In this manner, the media files 24 stored on the memory 14 could be periodically removed, added to or modified remotely using the network connection 18.

The network connection 18 could contain a wireless access point allowing the charging station 1 to provide wireless internet access through a connection to the internet to users.

### Retrofit:

In one aspect, the charging station would be a purpose built device including both the display unit and necessary display components for displaying visual content, such as advertising, on the display unit, as well as the necessary electrical components for the charging of at least one personal electronic device incorporated therein. In another aspect, a retrofit charging module can be provided for use in association with pre-existing display units.

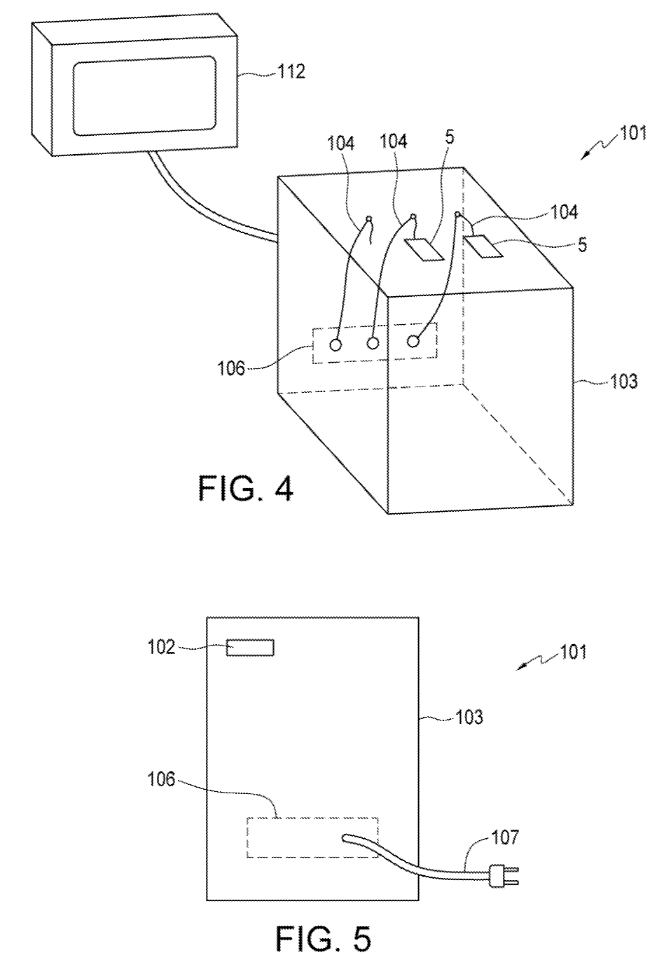

FIGS. 4 and 5 illustrate a retrofit charging station 101 in one aspect. Similar to the charging station 1 shown in FIGS. 1 and 2, the retrofit charging station 101 can include an enclosure 103, a plurality of charging interfaces 104, one or more power transformers 106 and a power cord 107. However, unlike the charging station 1 shown in FIGS. 1 and 2, the retrofit charging station 101 does not contain a display unit incorporated into it. Rather, the retrofit charging station 1 has a display interface 102 allowing the retrofit charging station 101 to be connectable to a pre-existing display unit 112, such as a LCD television, plasma television, computer monitor or other display device. In this manner, the retrofit charging station 101 would not contain a standalone display unit but would rather contain the necessary hardware for charging a personal electronic device 5 and means to be connectable to a pre-existing display unit 112.

The display interface 102 could be an HDMI interface, s-video interface, vga interface, component video interface or any other suitable interface capable of connecting to the desired type of pre-existing unit 112.

In this manner, the retrofit charging station 101 can be positioned or mounted alongside a pre-existing display unit 112 and then the display unit interface 102 used to operably connect the retrofit charging station 101 to the pre-existing display unit 112. When a user connects his or her personal electronic device 5 to the retrofit charging station 101 to charge the personal electronic device 5 using one of the charging interfaces 104, the retrofit charging station 101 can use the display unit interface 102 operably connected to the pre-existing display unit 112 to display visual content, such as advertising, on the pre-existing display unit 112.

In one aspect, the operation of the retrofit charging station 101 could be done using a control system similar to control system 10 shown in FIG. 3.

### Method:

In addition to the charging station outlined herein, the invention also comprises the method of providing for the charging of batteries in personal electronic devices in visible proximity or association with a display showing visual content, such as advertising material. The method comprises the steps of providing a charging station with the ability to charge the battery of at least one personal electronic device in association with a display unit to display visual content such as rotating advertisements so that during the use of the charging station the user of the charging station will be shown one or more advertisements during the time his or her personal electronic device is plugged into the charging station.

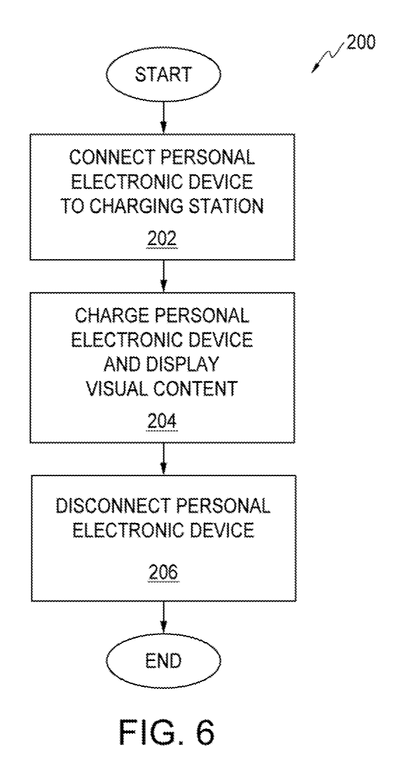

FIG. 6 is a flowchart illustrating a method 200 of displaying visual content in response to a user connecting his or her personal electronic device to a charging station to be charged. The apparatus which would be used in the conduct of method 200 could be a freestanding charging station such as charging station 1 shown in FIGS. 1 and 2, or it could be a retrofit charging station, such as the retrofit charging station 101 shown in FIGS. 4 and 5 with a pre-existing display unit 112 attached to the retrofit charging station 101 and provided in proximity to the retrofit charging station 101. The charging station is typically provided in a public location such as a hotel lobby, mall, convenience store, airport, etc. where a user from the general public can simply approach the charging station and use it to charge his or her personal electronic device.

Referring again to FIG. 6, a user connects his or her personal electronic device to the charging station, shown at step 202.

Upon application of the power of the charging station to the personal electronic device, charging would start on the battery on the personal electronic device, and as discussed elsewhere above this could either be automatic and free of charge or could be operated by some type of a payment device as well. In any event, the charging of the personal electronic device is shown at step 204, Simultaneously with the charging at step 204, visual content, such as advertising material, is displayed on a display device associated with the charging station. If a charging station similar to charging station 1 shown in FIGS. 1 and 2 is used, the visual content can be displayed on the display unit 2. If a charging station such as the retrofit charging station 101 is used, the visual content can be displayed the pre-existing display unit 112 connected to the retrofit charging station 101.

The visual content can continue to be displayed at step 204 as long as the charging station is being used to charge one or more personal electronic devices. The visual content can be rotated through different items throughout the timeframe that the personal electronic device was connected to the charging station.

At step 206, the personal electronic device can be disconnected and the consumer is finished with the charging station causing the method 200 to end, but the user was shown one or more pieces of visual content, such as advertisements, during the charging up their personal entertainment device. In this manner, the provision of the charging station in associated visible or visual proximity with the display, and displaying visual content such as advertising material throughout the timeframe that the personal entertainment devices being charged is achieved. The method could also accommodate different users or different personal electronic devices by adjusting the visual content which is displayed based upon the type of devices which are connected to the charging station, allowing certain advertisements to be directed to specific users.

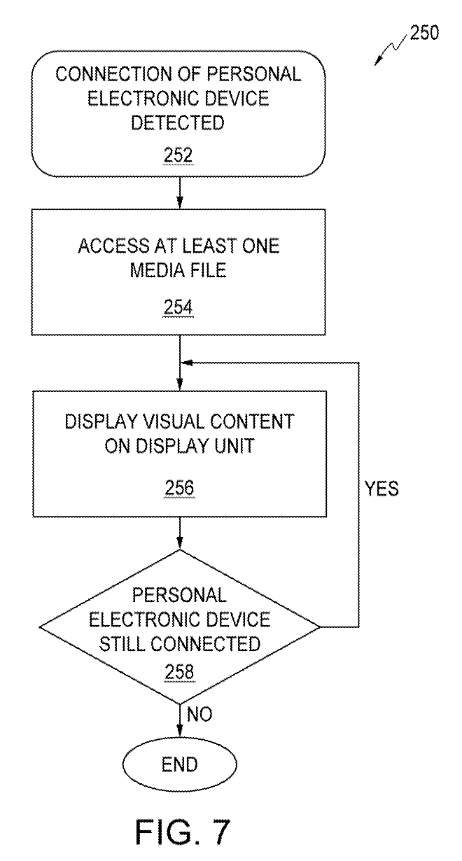

FIG. 7 is a flowchart illustrating a method 250 of operation, in one embodiment, of the charging station 1 shown in FIGS. 1 and 2 or retrofit charging station 101 shown in FIGS. 4 and 5 when a control system such as control system 10 shown in FIG. 3 is used.

Method 250 can start at step 252 when the processing unit 12 detects that a user has connected his or her personal electronic device 5 to the charging station 1 (or retrofit charging station 101) to be charged. At step 254, the processing unit 12 can access one or more of the media files 24 stored on the memory 14. The processing unit 12 can then use the data in the media file at step 256 to display visual content on the display device 2 (or pre-existing display device 112).

At step 258 the processing unit 12 can check to see if the personal electronic device 5 is still connected and being charged. If the personal electronic device 5 is still connected and being charged, the processing unit 12 can continue to display visual content on the display unit 2 (or pre-existing display unit 112). This could require the displaying of visual content based on data in another media file 24, repeating the display of the same visual content, etc.

If at step 258 the processing unit 12 determines that the personal electronic device 5 is no longer connected and being charged, the method 250 can end.

In one embodiment, if the number of personal electronic devices 5 being connected to charging station 1 (or charging station 101) is being tracked, the processing unit 12 can increase the count 26 stored in the memory 14. This can be done simultaneously at step 254, just before the method 250 ends or some other suitable time during the operation of method 250.

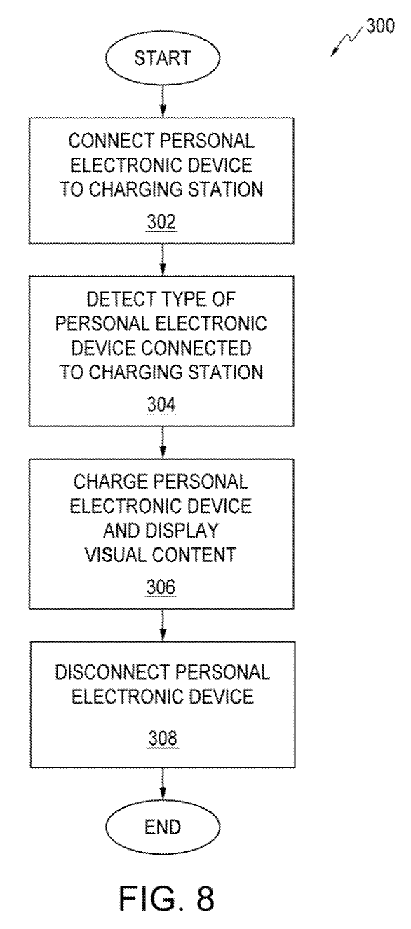

FIG. 8 is a flowchart of a method 300 for displaying visual content such as advertising while a user is charging his or her personal electronic device where the visual content is selected based on the type of personal electronic device being charged.

The personal electronic device is connected to the charging station by the consumer for charging as shown in step 302. Typically, the charging station is provided in a public location so that the user can simply be a member of the public with a personal electronic device to be charged and can simply walk up to the charging station and connect his or her personal electronic device to the charging station.

With the personal electronic device connected to the charging station at step 302, the type of electronic personal device can be detected at step 304. This detection of the type of personal electronic device can be by way of some type of user input, by some type of electronic detection, etc.

At step 306 the personal electronic device or devices connected to the charging station can be charged and visual content, such as advertising materials, wherein the visual content is selected based on the type of personal electronic device or devices connected to the charging station can be displayed.

Upon completion of charging as shown at step 308 the personal electronic device would be disconnected and the method 300 completed.

By determining the type of electronic device connected to the charging station at step 304, the visual content which is displayed can be tailored to a profile of the type of user who might have that device. For example if an MP3 player is connected to be charged, the visual content which is displayed might be advertising material related music or media and entertainment, whereas if it was determined that one or more business type e-mail devices were attached for charging, the visual content could be business channel advertising.

In this type of a case where the visual content being displayed was being modified based upon the type of device which was connected to the charging station, if the charging station or device was actually actively connected to a computer network such as the Internet for the streaming or download from time to time or on a real-time basis of the advertising material in question, streaming of appropriate visual content could be even more accurate based upon the access through the network connection to a wider storage repository than that which might be on board in the charging station itself.

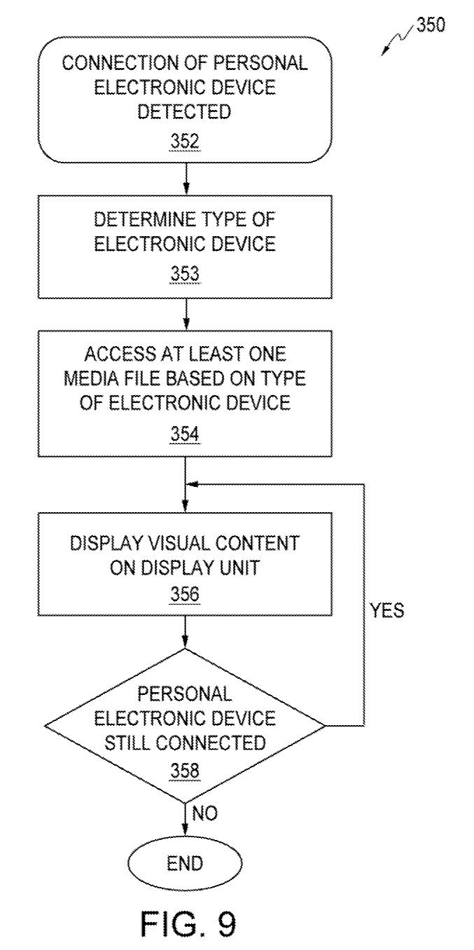

FIG. 9 is a flowchart illustrating a method 350 of operation in one embodiment, of the charging station 1 shown in FIGS. 1 and 2 or retrofit charging station 101 shown in FIGS. 4 and 5 when a control system such as control system 10 shown in FIG. 3 is used to select visual content based on the type of personal electronic device 5 being charged and displaying the selected visual content.

Method 350 can start at step 352 when the processing unit 12 detects that one or more personal electronic devices 5 have been connected to the charging station 1 (or charging station 101) to be charged. At step 353 the processing unit 12 will determine what the type of personal electronic devices 5 are being charged (e.g. mobile phone, specific type of mobile phone, MP3 player, etc.) The processing unit 12 could determine the type of personal electronic device 5 by a user input, electronic detection using the interface 16, by which of the charging interfaces 4 are being used or some other suitable way.

Once the type or types of personal electronic devices 5 are determined at 353, the processing unit 12 can select one of the media files 24 in the memory 14 based on the types of electronic devices 5 that are being charged by the charging station 1 (or charging station 101) at 354. For example, some of the media files 24 could indicate they are only for use with a specific type of personal electronic device 5 or specific set of types of personal electronic devices 5 and the media files 24 associated with type or types of electronic devices 5 being charged selected at step 353.

The processing unit 12 can then use the data in the selected media file 24 at step 356 to display visual content on the display device 2 (or pre-existing display device 112).

At step 358 the processing unit 12 can check to see if the personal electronic device 5 is still connected and being charged. If the personal electronic device 5 is still connected and being charged, the processing unit 12 can continue to display visual content on the display unit 2 (or pre-existing display unit 112). This could require the displaying of visual content based on data in another media file 24 that has been selected based on the type of personal electronic device that is connected, repeating the display of the same visual content, etc.

If at step 358 the processing unit 12 determines that the personal electronic device 5 is no longer connected and being charged, the method 350 can end.

In this manner, the visual content being displayed can be selected based on the type or types of personal electronic devices being charged by the charging station 1 (or charging station 101).

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A charging station for charging a personal electronic device, the charging station comprising:
an enclosure;
at least one charging interface for charging a personal electronic device;
at least one transformer operatively connected to the at least one charging interface to supply power to the at least one charging interface for charging the personal electronic device;
a display unit operative to display visual content in response to a user charging a personal electronics device using the charging station; and
a power cord for connecting the charging station to a local power source.

2. The charging station of claim 1 wherein more than one charging interface is provided.

3. The charging station of claim 2 wherein more than one type of charging interface is provided.

4. The charging station of claim 1 wherein the at least one charging interface is a power cord.

5. The charging station of claim 1 wherein the at least one charging interface is a docking station.

6. The charging station of claim 1 wherein the visual content is at least one of: a still image; an animation; and a video.

7. The charging station of claim 6 wherein the visual content is an advertisement.

8. The charging station of claim 1 wherein the display unit is a touchscreen display.

9. The charging station of claim 1 further comprising:
at least one computer readable memory, the at least one computer readable memory containing at least one media file containing visual content data;
at least one processing unit, the processing unit operatively connected to the memory and the display unit, the at least one processing unit operative to:
in response to determining a personal electronic device is being charged by the charging station, accessing the at least one media file stored on the at least one memory and displaying visual content on the display unit based on the visual content data in the at least one media file.

10. The charging station of claim 9 wherein the at least one computer readable memory contains a count indicating a number of personal electronic devices that have been charged by the charging station and the at least one processing unit is further operative to increase the count in response to a personal electronic device being connected to the charging station for charging.

11. The charging station of claim 9 wherein at least one memory contains a plurality of media files and the at least one processor is further operative to determine a type of personal electronic device connected to the at least one charging interface for charging and select one of the media files for display from the plurality of media files based on the type of personal electronic device connected to the at least one charging interface.

12. The charging station of claim 9 wherein the visual content is at least one of: a still image; an animation; and a video.

13. The charging station of claim 9 wherein the visual content is an advertisement.

14. A charging station for charging a personal electronic device, the charging station comprising:
an enclosure;
at least one charging interface for charging a personal electronic device;
at least one transformer operatively connected to the at least one charging interface to supply power to the at least one charging interface for charging the personal electronic device;
a display unit interface operative to connect to a display unit and display visual content on the display unit in response to a user charging a personal electronics device using the charging station; and
a power cord for connecting the charging station to a local power source.

15. The charging station of claim 14 wherein the visual content is at least one of: a still image; an animation; and a video.

16. The charging station of claim 14 wherein the visual content is an advertisement.

17. The charging station of claim 14 further comprising:
at least one computer readable memory, the at least one computer readable memory containing at least one media file containing visual content data;
at least one processing unit, the processing unit operatively connected to the memory and the display unit interface, the at least one processing unit operative to:
in response to determining a personal electronic device is being charged by the charging station, accessing the at least one media file stored on the at least one memory and using the display unit interface to display visual content on the display unit based on the visual content data in the at least one media file.

18. The charging station of claim 17 wherein at least one memory contains a plurality of media files and the at least one processor is further operative to determine a type of personal electronic device connected to the at least one charging interface for charging and select one of the media files from the plurality of media files for display based on the type of personal electronic device connected to the at least one charging interface.

19. A method comprising:
providing a charging station for charging a personal electronic device and a display unit associated with the charging station; and
in response to a personal electronic device being connected to the charging station to be charged, displaying visual content on the display unit associated with the charging station.

20. The method of claim 19 wherein the charging station is provided in a public location.

21. The method of claim 19 wherein the visual content is one of: a static image; an animation; and a video.

22. The method of claim 19 wherein the visual content is an advertisement.

23. The method of claim 19 wherein the method further comprises determining the type of personal electronic device being charged with the charging station and selecting the visual content based on the type of personal electronic device being charged.
